(19) United States
(12) Patent Application Publication
(10) Pub. No.: US 2014/0144632 A1
(43) Pub. Date: May 29, 2014

(54) THERMO-GAS-GENERATING SYSTEMS AND METHODS FOR OIL AND GAS WELL STIMULATION

(71) Applicants: Vacheslav Sosnin, Dzerzhinsk (RU); Ferdinant Sadriev, kakre-Egla (RU); Victor Kashaev, Dzerzhinsk (RU); Vladimir Ilyun, Dzerzhinsk (RU); Tatyana Demina, Dzerzhinsk (RU); Viktor Zavolzhski, Moscow (RU); Servei Valeshniy, Dzerzhinsk (RU); Boris Basyuk, Balashiha (RU); Albert Idiatulin, Troitsk (RU); Vladimir Burko, Moscow (RU)

(72) Inventors: Viktor Zavolzhski, Moscow (RU); Vladimir Burko, Moscow (RU); Albert Idiatulin, Troitsk (RU); Boris Basyuk, Balashiha (RU); Servei Valeshniy, Dzerzhinsk (RU); Vacheslav Sosnin, Dzerzhinsk (RU); Tatyana Demina, Dzerzhinsk (RU); Vladimir Ilyun, Dzerzhinsk (RU); Victor Kashaev, Dzerzhinsk (RU); Ferdinant Sadriev, Kakre-Egla (RU)

(21) Appl. No.: 14/090,928

(22) Filed: Nov. 26, 2013

(30) Foreign Application Priority Data
Nov. 26, 2012 (RU) 2012150375

(51) Int. Cl. C09K 8/84; E21B 43/16

(52) U.S. Cl. CPC C09K 8/845; E21B 43/16
USPC 166/280.2

(57) ABSTRACT

A method of treating a subterranean reservoir includes the steps of delivering a stabilized, non-explosive combustible oxidizing solution (COS) to a desired treatment area in the reservoir and activating the COS with an activator which reduces the pH of the COS. Upon activation, the COS reacts to produce sufficient heat and gas to stimulate the treatment area.

### PRIORITY FILING

This application claims the priority benefit of Russian Patent Application No. 2012/150,375 filed Nov. 26, 2012, the entire contents of which are incorporated herein, where permitted.

### FIELD OF THE INVENTION

The present invention comprises thermo-gas-generating system and methods for treating near-wellbore and radially extended treatment zones in a reservoir formation to reduce restrictions to flow and increase the production of the well.

### BACKGROUND

Various methods for stimulating production in an oil or gas well are well known in the art, including cleaning, perforating, and fracturing techniques. It is known to use exothermic chemical gas treatment to enhance production, both for a zone(s) within formation(s) near the wellbore and/or zones radially distal from the wellbore. In one example, gases are generated by the combustion of a gunpowder charge in the wellbore, to increase the downhole pressure sufficient to fracture the treated formation (Mischenko, I. Skvazhinnaya dobycha nefti. [Well Oil Production]. Oil and Gas. Gubkin Russian State University of Oil and Gas. Moscow. 2007, UDK 622.276.5, pg. 258). According to this method, a powder charge is delivered downhole into position near the zone to be stimulated using a wireline logging cable. Detonation of the powder charge rapidly produces gases which stimulates the formation in the zone of interest. This method using a gun powder charge has been used in the oil and gas industry for many years, but has proved to have a limited effect to stimulate the formation.

Another known method of near-wellbore formation stimulation is the use of thermal acidizing stimulation. These methods use thermal energy that is formed with the reaction of hydrochloric acid with magnesium metal (Mischenko, I., pp. 253-256), which heats the acid solution and the nearby formation, melting paraffin and other deposits that can then be removed or produced from the wellbore. Any excess acid, not spent on reaction with the magnesium, then dissolves and cleans the deposits, aided by the increased wellbore temperatures. The removal of the deposits and dissolved formation materials increases the fracture sizes and pore throats that serves as a path for formation fluids to be produced. The temperature increase is modest and is frequently not high enough to effectively remove the paraffin and other deposits that restrict the production of fluids from the formation. The reaction temperatures are limited because cold 15-18% hydrochloric acid solution is flushed through a layer of magnesium, and downhole temperatures do not increase to a level to produce the favorable conditions for the reaction of the hydrochloric acid with the formation materials or with the deposits.

Another similar method is to treat the formation near wellbore by injecting an unstabilized suspension made from an emulsion of oil, dry ammonium nitrate solution and magnesium granules into the near wellbore formation. Once injected, the reaction is initiated by injecting an activator into the near wellbore formation. The activator is typically a hydrochloric acid aqueous solution (A.s. 640023, MPK 2 E21V43/24). The hydrochloric acid solution reacts with the magnesium resulting in an increase in the temperature of the acid. The temperature continues to increase until decomposition of the ammonium nitrate is triggered and additional thermal energy is created. Thermal energy is produced from the reaction of magnesium and hydrochloric acid, decomposition of ammonium nitrate, and also the combustion of hydrogen with oxygen liberated from the nitrogen oxide reaction that occurs during the final stage of treatment being pumped. During the final stage of the reaction, the mixture of gases with hydrogen and oxygen may explode. This explosion has significant energy and because it occurs near wellbore, the resulting explosion can damage the integrity of well cement job, and compromise the integrity of the entire well.

Another known method involves the injection of a combustible oxidizing solution (COS) followed by a combustion activator, typically in the form of pelleted aluminum and chromium oxide powder (Russian Patent 2,126,084), or pellets containing a mixture of sodium borohydride and sodium dioxide (Russian Patent 2,154,733). The method is executed by pumping consecutive stages of magnesium and proppant with a water-base or oil-base fluid, COS and an acid solution (Russian Patent Application 2009/115,499).

These methods are disadvantageous because they require solid particles which do not always penetrate into the treatment zone. As well, there is a significant risk that the activation of the COS cannot be controlled due to the uneven distribution of the solid particles in the formation.

In another known method, a thermo-gas-generating solution (TGGS) is used which contains an aqueous solution of ammonium nitrate, ammonium chloride or diammonium phosphate. The TGGS is injected into the formation to be treated, and a powder charge is used to initiate the combustive reaction of the TGGS (Russian Patent 2,064,576). The main disadvantage of the method is that the use of an explosive as an activator for initiating the combustive reaction introduces operational complexity, and that the explosive can cause damage to the casing, cement and other down-hole equipment that may be present in the well.

Another known combustible oxidizing solution (COS) used for exothermic chemical gassing treatment uses glycerin as the combustible material (Russian Patent 2,100,583). However, the heat produced by this solution is typically insufficient to effectively remove paraffin and other deposits that restrict the productivity of the well in the wellbore and the near wellbore formation. As well, there is a risk of an unplanned reaction, which makes this form of treatment unsafe.

It is also known to use a chemical activator to initiate the decomposition of a COS (Russian Patent 2,154,733, mpk E21V43/263). In this case, an aqueous COS containing ammonium nitrate and a water soluble organic fuel creates high bottom hole pressure by releasing gas from the decomposition of the COS. The activator in this case is a pelleted mixture of sodium borohydride or sodium tetrahydraborate (85-95% wt) and sodium peroxide (5-15% wt). The activator is typically used at concentration of 2-5% of the weight of the COS. This method may be disadvantageous because the decomposition or combustion reaction may occur too rapidly, causing a pressure increase that exceeds the safe working limit and resulting in damage to the casing, wellbore cement and other equipment in the wellbore. Despite this, this method does not appear to produce sufficient pressure to fracture the formation and any fractures that are created are of limited width and depth of penetration in the formation. Furthermore, the use of a pelleted activator to initiate the reaction requires a special delivery device or technique.

Therefore, there is a need in the art for a system or method which may mitigate some or all of the limitations of the prior art.

### SUMMARY OF THE INVENTION

In one aspect, the invention comprises a method of treating a subterranean reservoir, comprising the steps of:

(a) delivering a stabilized, non-explosive, solids-free combustible oxidizing solution (COS) to a desired treatment area in the reservoir,

(b) activating the COS with an activator, wherein upon activation, the COS reacts to produce sufficient heat and gas to stimulate the treatment area.

In one embodiment, the activator is either consecutively injected after the COS, with or without a spacer slug of oil or water, or the activator may be encapsulated in an emulsion with the COS. The treatment area may be a near-wellbore zone and/or a zone radially distal from the wellbore within the reservoir. The distal zone may be several hundreds of meters from the wellbore.

In one embodiment, the COS comprises an aqueous solution of reactants comprising ammonium nitrate, preferably in a weight percent (w:w of the total composition) range of about 15.0-50.0%, sodium nitrite (preferably 15.0-40.0 wt %), and a stabilizer (preferably 0-2.0 wt %), with water (to 100% total).

In one embodiment, herein referred to as the BSS system, the COS may comprise an oil-in-water or water-in-oil emulsion, and may further comprise an oil such as produced crude oil (preferably 10.0-25.0%) and an emulsifier (preferably 0.1-2.0%). The activator may comprise an aqueous inorganic acid solution such as hydrochloric acid.

In another embodiment, herein referred to as the BSV system, the COS further comprises a viscosifier (preferably 0.1-0.5%), such as guar gum, a viscosifying surfactant or a polyacrylamide. The activator may comprise an organic acid solution, such as acetic acid. The activator may be emulsified with an oil, such as produced crude oil.

In any embodiment, the stabilizer may comprise sodium carbonate (soda ash), a hydroxide, quinolone, or a pyridine, or combinations thereof.

### BRIEF DESCRIPTION OF THE DRAWINGS

In the drawings, like elements are assigned like reference numerals. The drawings are not necessarily to scale, with the emphasis instead placed upon the principles of the present invention. Additionally, each of the embodiments depicted are but one of a number of possible arrangements utilizing the fundamental concepts of the present invention. The drawings are briefly described as follows:

FIG. 1 shows a graph of kinetics of temperature growth (degrees Celsius) over time (minutes) of a BSS COS solution after activation.

FIG. 2 shows a graph of heat release rate (milliWatts/grams of COS) over time (minutes) of a BSS COS after activation.

### DETAILED DESCRIPTION OF PREFERRED EMBODIMENTS

The invention describes a method to be used in the oil and gas service industry to stimulate oil and gas bearing formations both near wellbore (within several meters of the wellbore), and to several hundreds of meters radially from the wellbore. The invention can be used under normal and low reservoir pressures to improve the effective formation permeability of the near wellbore zones and increase the production of petroleum and natural gas wells. It is believed that the primary mechanism of stimulation is to extend and improve either or both naturally occurring formation fractures and induced fractures from other stimulation operations such as hydraulic fracturing. Furthermore, embodiments of the invention are capable of generating sufficient energy to create new formation fractures both near wellbore and deep within the formation to increase the flow and cumulative production of oil and gas from a wellbore. The reaction is intended to be non-explosive and does not requires a detonating charge to initiate the reaction results, and is therefore intrinsically safer than prior art that uses explosive reactions and detonations. Embodiments of the invention may also improve the injectivity of a fluid into a reservoir.

The chemical reactions which take place in the methods described herein produce a significant volume of gas and thermal energy that are useful independently, or can be used to enhance or supplement existing treatment technologies to increase the productivity of a well. In one embodiment, the rate of reaction can be controlled to generate a significant volume of gas in a short amount of time, ranging from microseconds to minutes. Under certain reservoir conditions, it is possible to customize the reaction rate to release a gas volume at a rate sufficiently high enough to extend and improve existing natural formation fractures, and also to induce additional fractures into the formation, further increasing the effective permeability of the formation. The heat and gas generated from the reaction decreases the viscosity and swells the formation fluids thereby improving the mobility of the formation fluids.

In one aspect, the invention comprises a stabilized, non-explosive combustible oxidizing solution (COS), which undergoes a chemical gassing exothermic reaction upon activation. In one embodiment, the COS comprises an aqueous solution comprising a nitrate salt and a nitrite salt that will react to produce thermal energy and gas. The nitrate salt may comprise ammonium nitrate. The nitrite salt may comprise sodium nitrite. The COS solution is stabilized with a stabilizer to prevent the reaction from occurring prior to activation, and to control the rate of the reaction after activation. The stabilizer may comprise a substance that increases the pH of the COS above about 5.0. Suitable stabilizers may include sodium carbonate (soda ash), potassium carbonate, potassium hydroxide, sodium hydroxide, pyridine, quinoline, or combinations thereof. The choice and quantity of stabilizer may be chosen to vary the threshold at which the reaction commences, and/or the reaction rate.

Without restriction to a theory, it is believed that at a sufficiently low pH, the components of the COS decompose to produce gas which is predominately or entirely nitrogen gas, in a series of complex exothermic reactions. An activator which reduces the pH of the COS, such as an inorganic or organic acid, is used to initiate the reaction. In one embodiment, the activator comprises hydrochloric acid, acetic acid, propionic acid, formic acid, sulphamic acid, or combinations thereof. The quantity or strength of the activator can be adjusted to also affect the rate of the reaction. To initiate the reaction, the activator only needs to contact a fraction of the COS. Once initiated, the COS will continue to react and fully decompose in a continuous reaction that proceeds without the addition of more activator. This continuous reaction of the COS will continue until either all the COS components have fully reacted, or the reaction is quenched by increasing the pH of the COS.

In another embodiment, the activator may comprise a salt which reacts with and consumes the stabilizer. Suitable examples may include chloride salts such as ferric or ferrous chloride, or cupric or cuprous chloride.

In one embodiment, the invention comprises the step of pumping a pre-blended stabilized COS into a wellbore, delivering it to a treatment area, and activating it with an activator to create an exothermic chemical gassing system (ECGS). The rate of energy production and quantity of energy can be controlled by both the chemical components and by the pumping procedures. The activator may be delivered sequentially, or may be delivered with the COS in an encapsulated or otherwise segregated form.

In one embodiment, the ECGS comprises a low viscosity aqueous ammonium nitrate and sodium nitrite solution in an oil-continuous emulsion, referred to herein as BSS. The oil may comprise produced crude oil, or a fuel oil such as diesel. In another embodiment, the ECGS comprises a controlled viscosity aqueous ammonium nitrate and sodium nitrite solution which includes a viscosifier, herein referred to as BSV. The BSV system physical properties, such as density and viscosity are highly customizable, such as by foaming the BSV with the injection of high pressure nitrogen. Both the BSS and BSV reactions may be initiated by pumping of an activator into the same formation treatment area containing the injected BSS or the BSV.

The reaction is initiated upon contact by the activator with the BSS or BSV COS. Once initiated, the reaction rate rapidly accelerates, resulting in the release of a significant amount of gas and heat in the treatment area of the formation. This rapid generation of heat and gas stimulates the formation and has been demonstrated in field trials, described below, to increase production. Without restriction to a theory, it is believed that well stimulation occurs through three primary mechanisms:
1. The rapid release of gas increases the pressure in the formation pore space and causes existing natural fractures to extend, existing fractures to widen, and create new fractures.
2. The thermal energy created from the reaction heats the surrounding fluids, causing thermal expansion, while the elevated temperature reduces the viscosity of the oil in the formation, promoting its flow.
3. The superheated gas produced by the reaction reacts with flow restricting deposits, such as asphaltenes and paraffins, to partially or completely remove such deposits from the formation pore space and to allow fluids to flow more freely in the formation.

Both the BSS and BSV systems comprise a combustible oxidizing solution (COS) comprising water and a nitrate salt, such as ammonium nitrate, and a nitrite salt, such as sodium nitrite. Both the BSS and BSV systems comprise components that will generate heat and gaseous products when a reaction is initiated with the acidic activator.

The BSS system utilizes an emulsion to create viscosity, but may also use the different phases of the emulsion, such as the outer or continuous phase and the inner or discontinuous phase, to segregate or encapsulate the reactive components in an emulsified fluid. In one embodiment, the BSS COS is prepared as an oil continuous phase emulsion, with the discontinuous phase being an aqueous ammonium nitrate, sodium nitrite and stabilizer solution, with an emulsifier added for the preparation of the emulsion. The COS emulsion is injected into formation, followed by the activator made of an inorganic acid aqueous solution, such as a hydrochloric acid. In one embodiment, and depending in part on the strength of the acid, the volume of the activator pumped may be at a ratio of about 1:1 BSS COS:activator, up to about 3:1 BSS COS:activator.

Like other well stimulation techniques, where an emulsion is used to create viscosity, the BSS emulsion may be specifically placed or directed to high permeability and naturally fractured formations. For example, the BSS emulsion may be injected and result in increased production from depleted highly fractured carbonate oil bearing formations, with bottom hole pressures of less than 1,000 kPa (145 psi).

In one embodiment, the BSS system may also implement the use of multiple continuous and discontinuous phases to encapsulate the reactants, as well as to encapsulate the activator. In one embodiment, a three-phase water-in-oil-in-water emulsion may be used where an inner phase comprises an aqueous activator such as a hydrochloric or acetic acid solution, a middle phase comprises an oil such as a produced crude oil or a fuel oil such as diesel, and an outer phase comprises the COS. This three-phase emulsion may obviate the need to pump a separate activator stage to initiate the reaction.

To initiate the reaction in the three phase emulsion, the activator in the inner phase would need to contact the COS in the outer phase through some environmental change which causes de-emulsification, such as a change in pH, temperature, ionic strength or mechanical energy like a change in pressure. As the emulsion begins to break, the activator and COS make contact and react to produce heat and gas. The middle oil phase may further fuel the reaction by oxidizing to produce additional heat and gas. The reaction continues to accelerate as the heat and gas further breaks the emulsion, causing a continuous reaction to proceed until all the reactants are consumed, or the pH of the system is increased to terminate the COS reaction, which is pH sensitive.

In one embodiment, the BSS system contains the following components (w/w %):

Combustible Oxidizing Solution:

| | |
|---|---|
| ammonium nitrate | 15.0-50.0% |
| sodium nitrite | 15.0-40.0% |
| stabilizer (soda ash and/or pyridine) | 0-2.0% |
| emulsifier | 0.1-2.0% |
| produced crude oil | 10.0-25.0% |
| water | up to about 60% |

Activator:

| | |
|---|---|
| hydrochloric acid | 15.0-37.0% |
| water | up to 85.0% |

In one embodiment, the BSV COS comprises an aqueous solution comprising ammonium nitrate, sodium nitrite, and a stabilizer. The BSV COS is viscosified with a viscosifier, such as guar gum, polyacrylamide or a viscosifying surfactant, to achieve the desired viscosity. The viscosity of the COS can be customized by varying the amount or type of viscosifier. If the BSV is required to have a high viscosity, a cross-linked viscosifier may be used. By controlling the viscosity, the BSV may be used in different applications, including using the BSV COS as a hydraulic fracturing fluid to carry proppant into a fracture. Additionally, high viscosity BSV fluids can be used in high permeability formations, such as highly fractured formations and/or depleted reservoir pressure formations, where less viscous fluids would be less effective for stimulating the well. Conversely, in low permeability or tight formations where a low viscosity fluid is desirable, the viscosifier can be reduced or omitted from the BSV system to lower the viscosity close to that of water.

Once the COS solution with the desired viscosity is injected into the treatment area of the formation, an activator is injected into the same treatment area. For the BSV system, in one embodiment, the activator comprises an aqueous organic acid solution, and may further comprise an oil, such as produced crude oil or a fuel oil such as diesel, which may optionally be emulsified. In one embodiment, the organic acid may comprise acetic acid. This activator solution or emulsion is then injected into the same treatment area with the previously injected BSV COS to initiate the exothermic chemical gassing reaction. Since the activator for the BSV system is made from an organic acid, such as acetic acid, the BSV system is safe for use in wells containing tubulars and other components made from stainless steel and nickel alloys, where conventional stimulation methods using a hydrochloric acid solution can damage these well components.

In one embodiment, the BSV system contains the following components (w/w %):

Combustible Oxidizing Solution:

| | |
|---|---|
| ammonium nitrate | 15.0-50.0% |
| sodium nitrite | 15.0-40.0% |
| stabilizer (such as soda ash) | 0-2.0% |
| emulsifier | 0.1-2.0% |
| viscosifier (guar or polyacrylamide) | 0.1-0.5% |
| water | up to about 70% |

Activator:

| | |
|---|---|
| acetic acid | 15-100% |
| water | up to 85% |

The BSS and BSV systems both comprise components that are readily available and used in other applications. The methods of their use comprise relatively convenient and easy preparation steps due to simple and quick mixing procedures for the solution. The components present well understood health, safety and environmental risks, and there are well-known methods to minimize such risks. To increase safety of surface handling of the COS, the risk of an unexpected reaction at surface can be lowered by increasing the pH through the addition of a stabilizer such as soda ash. The system is compatible with encapsulation technology and methods, such as an encapsulated activator, that could enhance the functionality and customizability of the system.

If an organic acid is used, the compositions are relatively non-corrosive and can be used with well completion components containing stainless steel and nickel alloys that are sensitive to other stimulation fluids containing strong inorganic acids. Both systems are capable of injecting stimulating fluid deep within the formation to reduce the risk of negatively impacting the wellbore integrity and allowing for greater treatment coverage in the formation to maximize the incremental production.

There is virtually no risk of sedimentation of the systems because they do not use any solids that could precipitate, bridge off and restrict the injection of the fluid or flow back of fluid from the formation. Also, because of the lack of solids in the system, there is little risk of erosion and material loss of wellbore components. In alternative embodiments, a non-reactant solid may be added as a hydraulic fracturing proppant.

The rate of reaction can be controlled to optimize the treatment objectives, such as maximizing the thermal output of the reaction or maximizing the rate and amount of gas generated. By customizing the reaction to produce the desired amount of heat and gas specific well treatment objectives can be achieved. For example, if the treatment objective is to remove deposits such as paraffin, then more heat and less gas from a slow rate of reaction over several hours may be desired. If the treatment objective is to create additional formation fractures deep within the formation the desired reaction may be to maximize the volume of gas generated with a fast rate of reaction over a few seconds or minutes. The sensitivity threshold to initiate the decomposition can be controlled to meet the specific reservoir conditions, such as reservoir temperature.

In one embodiment, the system may feature customizable fluid rheology. The viscosity of the system can be controlled from essentially that of water to several hundred centipoises, which may allow the system to be used in a conventional hydraulic fracturing application. In one embodiment, the viscosifier may be crosslinked utilizing the same pH sensitivity of the COS. The density and fluid rheology of the system can also be controlled through the use of nitrogen gas injection into the COS to produce a two phase fluid, such as a nitrified or foamed fluid.

In operation, and in one embodiment, for the safe and effective use of the BSS and BSV systems to successfully treat a well, the downhole temperature of the treatment zone should be about 60° Celsius or greater. At temperatures above 60° C., the reaction will generate gas at a rate (cubic meters per second) sufficient for the treatment to be effective. However, below 60° C., the reaction rate may not be sufficient, and it may become necessary to inject acid accelerators or additional activators, or reduce the amount of stabilizer in the COS, to ensure that the rate of the reaction and gas generation is adequate for the treatment.

By using different stabilizers at varying quantities, the system can be made stable at ambient temperatures (20 to 25° C.) for several days to facilitate greater flexibility in handling the fluids. The COS is controlled and stabilized by increasing the pH level of the COS at ambient temperatures. When at a pH higher than about 5 and with a suitable stabilizer, the COS is very stable and will not degrade at ambient temperatures. In these conditions, the COS can be stored for several days. If the COS is heated to 50° C. within 30 minutes, it will still remain stable, with only an insignificant amount of gas being generated. Furthermore, after heating to 50° C., the COS continues to remain stable for some time.

This specification describes various examples of the claimed invention. Although the invention has been described in language specific to features of a composition and/or acts in a method, the invention is defined in the claims, and is not necessarily limited to the specific features or acts, or combinations of features and acts described, which are only intended to be exemplary implementations of the claimed invention. The following examples are intended to exemplify embodiments of the invention, and should not be looked at to narrow the claimed invention unless specifically claimed in that fashion.

### EXAMPLE 1

### Laboratory Testing Rates of Reaction—BSS

The chemical reaction of the sodium nitrite with ammonium nitrate generates nitrogen gas, water and heat, and has a rate of reaction that is pH dependent on a number of equilibrium processes. In laboratory testing, the pH of a COS solution was increased with sodium carbonate (soda ash), and the pH was decreased with hydrochloric or acetic acid.

Laboratory samples of BSS COS were prepared using a well-known commercially available emulsifier, as follows. A COS discontinuous phase was prepared by mixing ammonium nitrate (25.0-40.0 g), sodium nitrite (15.0-30.0 g) and water (30.0-50.0 g), which was then heated to 50° C. The solution had a density of 1.13 to 1.39 g/cm³.

To this solution, soda ash (2.0-10.0 g) and pyridine (0.01-1.0 g) were added and mixed to stabilize the solution. The solution was then emulsified with produced crude oil (8.0 to 30.0 g) and an emulsifier (0.01-1.0 g) at room temperature, in an agitator at 2,400 to 2,500 rpm for 3 to 4 minutes.

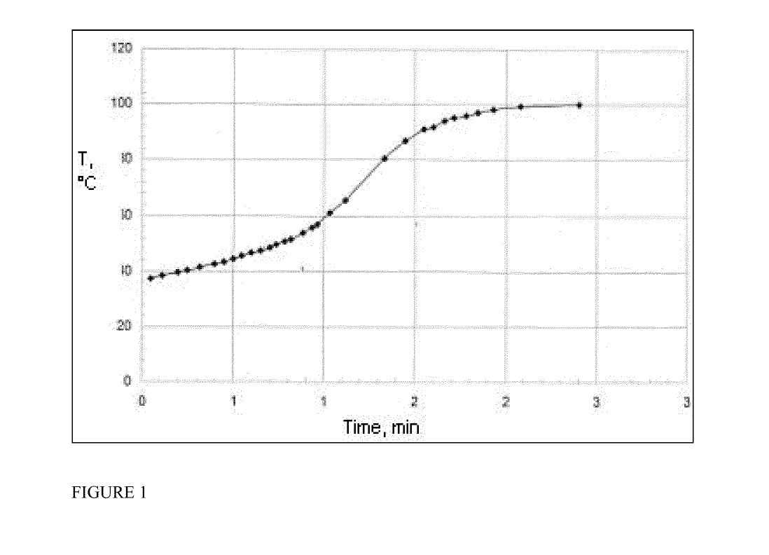

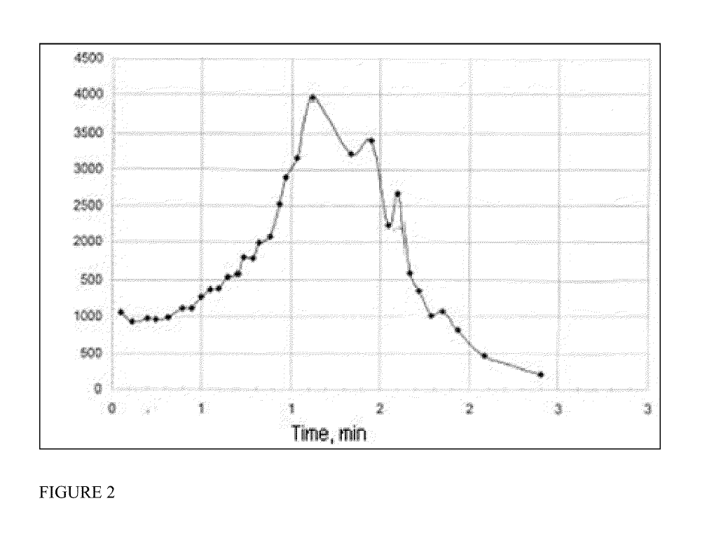

The reactive capacity of this BSS COS emulsion with the addition of an activator to initiate the decomposition reaction was assessed as follows. Approximately 40 g of the BSS COS emulsion was put into a test tube with a diameter of 30 mm and between 10 g to 20 g of 10% to 30% hydrochloric acid aqueous solution was added to the test tube. The capacity of the reaction was determined visually by observing the emission of gases and measuring the changes to the temperature, which were measured by a thermocouple submerged into the reactive mass with the digital output displayed and recorded on a computer. A significant release of gases and an increase in temperature were observed. The results of the BSS system reactions are presented in the Table 1 and in FIGS. 1 and 2. Table 1 shows the temperature over time and demonstrates how the reaction creates a significant amount of heat. FIG. 1 show the temperature growth over time, heat release rate and released heat of the reaction. Table 1 and FIGS. 1 and 2 shows the results of the analysis of the BSS exothermic chemical gassing composition in terms of the heat release rate in the adiabatic mode.

TABLE 1
Results of the laboratory tests of the BSS exothermic chemical gassing system in the adiabatic mode.

| | | | | Degree C. | Degree C. | Degrees C. | | |
|---|---|---|---|---|---|---|---|---|
| | | | | Inside Reaction | Inside Reaction | Outside Reaction | | |
| | | | sec | Vessel | Vessel | Vessel | milliWatts/gram | Joules/gram |
| Time from experiment start | | | Delta | Temperature | Temperature | Temperature | Delta Energy | Total |
| min | | h:m:s | Time | Gauge A | Gauge A | Gauge | (dq) | Energy (Q) |
| 0.05 | 12:23:09 | 0:00:03 | 3.88 | 36.270 | 37.295 | 23.59 | 1,058.195 | 4.102 |
| 0.12 | 12:23:13 | 0:00:07 | 4.38 | 37.295 | 38.320 | 23.59 | 937.286 | 8.203 |
| 0.20 | 12:23:18 | 0:00:12 | 4.25 | 38.320 | 39.355 | 23.75 | 973.807 | 12.344 |
| 0.25 | 12:23:21 | 0:00:15 | 4.25 | 39.355 | 40.381 | 23.81 | 965.074 | 16.445 |
| 0.32 | 12:23:25 | 0:00:19 | 4.13 | 40.381 | 41.396 | 23.89 | 984.849 | 20.508 |
| 0.40 | 12:23:29 | 0:00:24 | 3.63 | 41.396 | 42.412 | 23.99 | 1,120.381 | 24.570 |
| 0.45 | 12:23:32 | 0:00:27 | 3.63 | 42.412 | 43.418 | 24.14 | 1,109.914 | 28.594 |
| 0.50 | 12:23:35 | 0:00:30 | 3.25 | 43.418 | 44.453 | 24.28 | 1,273.647 | 32.734 |
| 0.55 | 12:23:38 | 0:00:33 | 3.00 | 44.453 | 45.479 | 24.36 | 1,366.732 | 36.836 |
| 0.60 | 12:23:42 | 0:00:36 | 3.00 | 45.479 | 46.514 | 24.59 | 1,379.748 | 40.977 |
| 0.65 | 12:23:45 | 0:00:39 | 2.75 | 46.514 | 47.568 | 24.73 | 1,534.091 | 45.195 |
| 0.70 | 12:23:48 | 0:00:42 | 2.63 | 47.568 | 48.604 | 24.98 | 1,577.381 | 49.336 |
| 0.73 | 12:23:50 | 0:00:44 | 2.25 | 48.604 | 49.609 | 25.08 | 1,786.606 | 53.359 |
| 0.78 | 12:23:53 | 0:00:47 | 2.38 | 49.609 | 50.664 | 25.29 | 1,776.316 | 57.578 |
| 0.82 | 12:23:55 | 0:00:49 | 2.13 | 50.664 | 51.719 | 25.44 | 1,985.294 | 61.797 |
| 0.88 | 12:23:59 | 0:00:53 | 2.00 | 52.734 | 53.770 | 25.76 | 2,070.313 | 70.000 |
| 0.93 | 12:24:02 | 0:00:56 | 1.63 | 54.814 | 55.840 | 25.96 | 2,522.486 | 78.281 |
| 0.97 | 12:24:04 | 0:00:58 | 1.50 | 55.840 | 56.924 | 26.16 | 2,890.625 | 82.617 |
| 1.03 | 12:24:08 | 0:01:02 | 1.38 | 60.020 | 61.104 | 26.54 | 3,153.409 | 95.000 |
| 1.12 | 12:24:13 | 0:01:07 | 1.13 | 64.365 | 65.479 | 26.98 | 3,958.333 | 112.383 |
| 1.33 | 12:24:26 | 0:01:20 | 1.38 | 79.268 | 80.371 | 28.53 | 3,210.227 | 171.992 |
| 1.45 | 12:24:33 | 0:01:27 | 1.25 | 85.713 | 86.777 | 29.45 | 3,406.250 | 197.773 |
| 1.55 | 12:24:39 | 0:01:33 | 1.88 | 89.834 | 90.879 | 30.32 | 2,229.167 | 218.438 |
| 1.60 | 12:24:41 | 0:01:36 | 1.63 | 90.879 | 91.963 | 30.62 | 2,666.628 | 222.773 |
| 1.67 | 12:24:45 | 0:01:40 | 2.63 | 92.998 | 94.043 | 31.26 | 1,592.262 | 231.094 |
| 1.72 | 12:24:48 | 0:01:43 | 3.00 | 94.043 | 95.059 | 31.78 | 1,354.167 | 235.156 |
| 1.78 | 12:24:53 | 0:01:47 | 4.00 | 95.059 | 96.074 | 32.51 | 1,015.371 | 239.219 |
| 1.85 | 12:24:57 | 0:01:51 | 3.88 | 96.074 | 97.109 | 33.28 | 1,068.273 | 243.359 |
| 1.93 | 12:25:02 | 0:01:56 | 5.00 | 97.109 | 98.135 | 34.27 | 820.313 | 247.461 |
| 2.08 | 12:25:11 | 0:02:05 | 8.75 | 98.135 | 99.141 | 36.10 | 459.769 | 251.484 |
| 2.40 | 12:25:30 | 0:02:24 | 19.63 | 99.141 | 100.147 | 40.36 | 204.964 | 255.508 |

### EXAMPLE 2

### Laboratory Testing Rates of Reaction—BSV

BSV is a high viscosity, aqueous COS with the desired viscosity of the system being achieved from the addition of guar gum (GG) or polyacrylamide (PAA) to the COS. To stabilize the COS, an aqueous soda ash solution was added to the COS.

Laboratory samples of the viscous BSV COS were prepared (% total weight) by mixing, ammonium nitrate (15.0-50.0%), sodium nitrite (15.0-40.0%) and water (up to 70.0%). To this solution, soda ash (up to 1.5%) stabilizer was added and mixed, to create a homogeneous solution. To this solution, guar gum (up to 1.0%) was added and stirred at 30° C. The resulting solution was viscous and homogeneous.

The reactive capacity of this viscous BSV COS with the addition of an activator to initiate the decomposition reaction was assessed as follows. Approximately 100 ml of viscous BSV COS was put into an insulated flask with the diameter of 45 mm, and a thermometer was set into the solution, and the initial temperature recorded. The following aqueous activator solutions were prepared:
a. AA—acetic acid
b. FA—formic acid
c. PA—propionic acid
d. SA—sulphamic acid
e. GG—guar gum
f. PAA—polyacrylamide

The aqueous activator solution was mixed with produced crude oil, which may or may not form an emulsion. The oil and activator solution or emulsion was added to the COS but not stirred, and the temperature recorded. The reaction was monitored by the intensity of the gas released and the changes in temperature over time. Various combinations of activator, oil and COS where experimented with. The volumes of the various combinations and the observations for the reactions were recorded in Table 2.

TABLE 2
Results of the analysis of the BSV exothermic chemical gassing composition (% wt)

| Emulsion or a solution of the | | | | | | | | | | | | | |
|---|---|---|---|---|---|---|---|---|---|---|---|---|---|
| activator | | | | COS | | | | | | | Temperature, | | |
| oil | water | activator | | water | Viscosifier | | NaNO₂ | NH₄NO₃ | stabilizer | | ° C. | | Time to reach max |
| % | % | name | % | % | name | % | % | % | name | % | initial | max | temperature, min. |
| 89 | — | AA | 11 | 47 | — | — | 21 | 31 | KOH | 1 | 22 | 100 | 12.2 |
| — | — | AA | 100 | 69 | — | — | 15 | 15 | Na₂CO₃ | 1 | 20 | 95 | 1.0 |
| — | 80 | SA | 20 | 30 | PAA | 0.15 | 28 | 40 | Na₂CO₃ | 1.5 | 20 | 100 | 0.5 |
| | | | | | | | | | pyridine | 0.35 | | | |
| — | 75 | HCl | 25 | 30 | PAA | 0.15 | 38.5 | 30 | NaOH | 1.0 | 21 | 99 | 0.5 |
| | | | | | | | | | pyridine | 0.35 | | | |
| — | 65 | HNO₃ | 35 | 36 | PAA | 0.25 | 25 | 37 | K₂CO₃ | 1.2 | 18 | 99.5 | 1.0 |
| | | | | | | | | | quinoline | 0.55 | | | |
| — | 75 | FeCl₃ | 25 | 47 | — | — | 21 | 31 | Na₂CO₃ | 1 | 20 | 97.5 | 2.0 |
| — | 75 | CuCl | 25 | 47 | — | — | 21 | 31 | Na₂CO₃ | 1 | 21 | 87 | 5.0 |
| 95 | — | AA | 5 | 40 | — | — | 30 | 29 | KOH | 1 | 20 | 94 | 14.0 |
| 99.5 | — | AA | 0.5 | 40 | — | — | 30 | 29 | KOH | 1 | 20 | 72 | 21.0 |
| 81.0 | 6 | AA | 13 | 36 | PAA | 0.25 | 25.4 | 37 | Na₂CO₃ | 1.2 | 19 | 102 | 37.0 |
| | | | | | | | | | pyridine | 0.15 | | | |
| 80 | 10 | AA | 10 | 46 | PAA | 0.3 | 21 | 31 | Na₂CO₃ | 1.5 | 24 | 97 | 53.0 |
| | | | | | | | | | pyridine | 0.2 | | | |
| 60 | 32 | AA | 8 | 46 | GG | 0.2 | 21 | 31 | KOH | 1.1 | 25 | 85 | 31.0 |
| | | | | | | | | | pyridine | 0.2 | | | |
| 60 | 32 | AA | 8 | 46 | GG | 0.1 | 21 | 31 | KOH | 1.2 | 23 | 97 | 40.0 |
| | | | | | | | | | pyridine | 0.2 | | | |
| 88 | — | AA | 12 | 45.6 | PAA | 0.5 | 21 | 31 | KOH | 1.2 | 25 | 71.5 | 16.0 |
| | | | | | | | | | pyridine | 0.2 | | | |
| 60 | 32 | AA | 8 | 45.5 | PAA | 0.6 | 21 | 31 | KOH | 1.2 | 23 | 40 | 180.0 |
| | | | | | | | | | quinoline | 0.2 | | | |
| 80 | 10 | FA | 10 | 36 | PAA | 0.25 | 25.4 | 37 | KOH | 1.2 | 20 | 100 | 20.0 |
| | | | | | | | | | pyridine | 0.2 | | | |
| 80 | 10 | PA | 10 | 36 | PAA | 0.25 | 25.4 | 37 | KOH | 1.2 | 21 | 85 | 37.0 |
| | | | | | | | | | pyridine | 0.2 | | | |
| 80 | 10 | AA | 10 | 36 | PAA | 0.25 | 25.4 | 37 | Na₂CO₃ | 1.2 | 26 | 104 | 32.0 |
| | | | | | | | | | pyridine | 0.15 | | | |
| 80 | 10 | AA | 10 | 36 | — | — | 27¹ | 37 | — | — | 24 | 100 | 24 |

### EXAMPLE 3

### Field Trial of BSS

The treatment method of using a BSS exothermic chemical gassing system includes the injection of an emulsion comprising a continuous oil phase with a discontinuous Combustible Oxidizing Solution (COS) phase. The emulsion was prepared and pumped down the wellbore, followed by a spacer fluid of either oil or water to displace the COS emulsion out of the wellbore and place it into the treatment area of the formation. The BSS activator aqueous hydrochloric acid solution was then pumped into the wellbore and then displaced from the wellbore and into the treatment area with water.

Mixing of injected COS and activator in the formation pore spaces and fractures causes initiation of the decomposition reaction that generates of a vast amount of heat and gases, as confirmed in the laboratory tests. The gases generated during the reaction inside the fractures and pore spaces created pressure which expand the existing fractures and create new fractures in the formation, thus creating new paths for petroleum and natural gas to flow into the wellbore. An increase in temperature further expands the gas and further increases the downhole pressure and temperature, accelerating the decomposition of the COS and continuing to increase the temperature.

The first stage of a field trial was to prepare the COS by pumping 4,800 liters into a 10 m³ mixing tank and heating to about 45 to 50° C. with a steam truck. While continuously circulating the heated water, 190 kg of soda ash was added and dissolved, followed by 3,900 kg of ammonium nitrate. To this solution and while continuing to circulate, 2,700 kg of sodium nitrite was added to the mixing tank. The density of the prepared COS solution was 1.32 g/cm³.

The second stage is to create a continuous oil phase emulsion by mixing 4.0 m³ of produced crude oil and 9.4 m³ of the prepared COS, with an emulsifier to prepare a total volume of the emulsion of 13.5 m³.

At the third stage, the entire volume of the emulsion was pumped into the wellbore. Then 1.0 m³ of oil spacer was pumped into the wellbore, followed by the BSS activator which comprised 5.6 m³ of 12-14% hydrochloric acid aqueous solution. A displacing volume (10 m³) of produced water was then pumped into the wellbore.

The well production before treatment was 2 tonnes/day of oil. The well production after the treatment had been completed and downhole equipment had been installed reached 7-9 tonnes/day of oil.

### EXAMPLE 4

### Field Trial of BSV System

The treatment method of using the BSV system includes the injection of a high viscosity aqueous ammonium nitrate and sodium nitrite with stabilizers. The high viscosity COS is displaced from the wellbore with a spacer of either oil or water to displace the viscous COS out of the wellbore and into the treatment area of the formation. The BSV activator aqueous organic acid, such as acetic acid, and oil solution is then pumped into the wellbore and displaced with water into the same treatment area.

Mixing of the viscous COS and activator solution in the formation pore spaces and fractures initiates a reaction accompanied by the release of a significant amount of heat and gases. The gases generated during the reaction in the formation increases the downhole pressure to expand fractures and induce new fractures in the formation, thus creating new paths for petroleum and natural gas to flow into the wellbore. An increase in temperature expands the gases and further increases the downhole pressure and temperature, further accelerating the decomposition of the ammonium nitrate and continuing to increase the temperature.

The field trial of the BSV system was executed as follows. The first stage was to prepare the COS by pumping 5,200 liters of water into a 10 m³ mixing tank which was then heated to 45 to 50° C. with a steam truck. While continuously circulating the heated water, 170 kg of soda ash was added and dissolved, followed by 5,100 kg of ammonium nitrate and 10 kg of polyacrylamide. To this solution and while continuing to circulate, 3,300 kg of sodium nitrite and 30 liters of additional pyridine stabilizer was added to the mixing tank. The density of the prepared COS solution was 1.38 g/cm³.

The second stage is to separately prepare the organic acid-in-oil BSV activator emulsion. In a separate mix tank, 4,800 liters of oil, 15 liters of emulsifier and 950 liters of 70% acetic acid aqueous solution was continuously circulated and mixed to create a continuous oil phase emulsion.

At the third stage, 10.0 m³ of the viscous COS was pumped into the wellbore. Then a 1.0 m³ volume of oil spacer was pumped into the wellbore, followed by the 5.8 m³ of the BSV activator emulsion. Finally, a displacing volume of 20 m³ of produced water was pumped in to the wellbore.

The well production prior the treatment was 2 tonnes/day of oil. The well production after the treatment was completed and downhole pumping equipment had been installed reached 10-12 tonnes/day of oil.

1. A method of treating a subterranean reservoir, comprising the steps of:
(a) delivering a stabilized, non-explosive combustible oxidizing solution (COS) to a desired treatment area in the reservoir,
(b) activating the COS with an activator which reduces the pH of the COS, wherein upon activation, the COS reacts to produce sufficient heat and gas to stimulate the treatment area.

2. The method of claim 1 wherein the activator is either consecutively injected after the COS, or is encapsulated in an emulsion with the COS.

3. The method of claim 1 wherein the treatment zone is a near well-bore zone and/or a zone radially distal from the wellbore within the reservoir.

4. The method of claim 1 wherein the COS comprises an aqueous solution comprising:
(a) a nitrate salt,
(b) a nitrite salt, and
(c) a stabilizer.

5. The method of claim 4 wherein the nitrate salt comprises ammonium nitrate.

6. The method of claim 4 wherein the nitrate salt comprises sodium nitrite.

7. The method of claim 6 wherein the weight percent composition (w:w) of the COS comprises ammonium nitrate of 15.0-50.0%, sodium nitrite of 15.0-40.0%, and stabilizer of 0-2.0%.

8. The method of claim 4 wherein the COS comprises an oil-in-water or water-in-oil emulsion, and further comprises and oil and an emulsifier.

9. The method of claim 8 wherein the composition comprises oil in a weight percent of 10.0-25.0, and emulsifier in a weight percent of 0.1-2.0%.

10. The method of claim 4 wherein the COS further comprises a viscosifier.

11. The method of claim 10 wherein the viscosifier comprises guar or a polyacrylamide in a weight percent amount of 0.1-0.5%.

12. The method of claim 6 wherein the COS comprises a BSS composition, and the activator comprises an aqueous inorganic acid solution.

13. The method of claim 10 wherein the activator comprises hydrochloric acid.

14. The method of claim 6 wherein the COS comprises a BSV composition, and the activator comprises an organic acid solution or emulsion.

15. The method of claim 14 wherein the activator comprises acetic acid, formic acid, propionic acid or sulphamic acid.

16. The method of claim 14 wherein the COS is nitrified or foamed prior to placement in the treatment area.

17. The method of claim 8 wherein the activator is emulsified within the COS, in a water-in-oil emulsion.

18. The method of claim 4 wherein the stabilizer comprises sodium carbonate, a hydroxide, or a pyridine, combinations thereof.

19. The method of claim 1 wherein the COS is solids-free.

20. The method of claim 1 wherein the activator is encapsulated.

21. The method of claim 20 wherein the activator is encapsulated by a three-phase emulsion, comprising an inner phase comprising the activator, a middle phase comprising an oil, and an outer phase comprising the COS.

22. The method of claim 10 wherein the COS comprises a fracturing proppant, and the COS is sufficiently viscous to transport the proppant into the treatment area.
